(19) United States
(12) Patent Application Publication
(10) Pub. No.: US 2007/0226172 A1
(43) Pub. Date: Sep. 27, 2007

(54) File-management apparatus, file-management method, and computer product

(75) Inventor: Eisuke Tajima, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/447,959

(22) Filed: Jun. 7, 2006

(30) Foreign Application Priority Data
Mar. 23, 2006 (JP) 2006-081078

(51) Int. Cl. G06F 17/30

(52) U.S. Cl. 707/1

(57) ABSTRACT

A file-management apparatus monitors the boot process of an application to store information related to the process and accesses thereto in an access table or a process table. The file-management apparatus identifies other files read in the process which read the main file in the access table, registers the identified files into a relation table as related files, creates a tree of the logical relation structure among the files, and displays the tree on an output unit.

### BACKGROUND OF THE INVENTION

1. Field of the Invention

The present invention generally relates to managing digital files and specifically relates to managing digital files based on dynamic relations between the digital files.

2. Description of the Related Art

Before migrating an application from one computer to another and the like, it is required to identify and copy specific files (files related to setting a software configuration or essential to booting the application) and output the copied files to the destination of the application. It is also required to identify, copy, and output other files related to each of the specific files at the same time.

As a typical technology to identify the specific files and related files, there have been technologies of writing the configuration in the form of a file or the like using an export function; presuming the software and the function related to the file based on the extension thereof; and presuming relation with the file based on a tool that manages the file. One example of such a tool is explorer (registered trademark).

Japanese Patent Publication No. 2003-196130 discloses another technology to categorize the files based on the importance thereof. The importance is based on the frequency of certain character strings, which is determined by extracting a plurality of character strings from the file; and counting the frequency of the extracted character strings in the whole file. The technology can be used to identify the files.

However, according to the conventional-technologies, because a user cannot know dynamic relations based on a logical relational structure among the files (for example, files read in the same boot process), there is a problem that the user cannot identify the files based on the dynamic relation.

Namely, with the technology of writing the configuration in the form of the file or the like using the export function, only the files for setting the configuration are written. This leads to a problem that the user cannot know the dynamic relation based on the logical relational structure among the files to identify the files.

With the technology of presuming the software and the function related to the file based on the extension thereof, the categorization by the extension is rough. This leads to the same problem as described above.

With the technology of presuming relation with the file based on a tool that manages the file, the user can know only static relations (for example, files in the same folder) among the files based on the physical-relational structure. This also leads to the same problem.

With the technology disclosed in Japanese Patent Publication No. 2003-196130, the files are categorized by only the importance. This also leads to the same problem.

### SUMMARY OF THE INVENTION

It is an object of the present invention to at least partially solve the problems in the conventional technology.

According to an aspect of the present invention, a file-management apparatus includes a monitoring unit that monitors a process of software to register file names of digital files read in the process in an access table in association with a process identification that uniquely identifies the process; and a relation-registering unit that registers a file name of a digital file read in the process as a related file in a relation table in association with each digital file in the access table.

According to another aspect of the present invention, a file-management method includes monitoring a process of software to register file names of digital files read in the process in an access table in association with a process identification that uniquely identifies the process; and registering a file name of a digital file read in the process as a related file in a relation table in association with each digital file in the access table.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an outline and features of a file-management apparatus according to a first embodiment of the present invention;

FIG. 2 is a detailed block diagram of the file-management apparatus shown in FIG. 1;

FIG. 3 is an example of the contents of an access table shown in FIG. 1;

FIG. 4 is an example of the contents of a process table shown in FIG. 1;

FIG. 5 is an example of the contents of a relation table shown in FIG. 1;

FIG. 6 is an example of display of a tree;

FIG. 7 is a schematic for explaining how a boot process is monitored;

FIG. 8 is a flowchart for explaining a process of acquiring access information in the file-management apparatus;

FIG. 9 is another flowchart for explaining a process of acquiring process information;

FIG. 10 is a flowchart for explaining a process of registering relation information;

FIG. 11 is a flowchart for explaining a process of creating a tree;

FIG. 12 is a flowchart for explaining algorism for creating a tree;

FIG. 13 is a flowchart for explaining a process of labeling with essential or frequent; and

FIG. 14 is a block diagram of a computer that implements the methods according to the embodiment.

### DETAILED DESCRIPTION OF THE PREFERRED EMBODIMENTS

Exemplary embodiments of the present invention will be explained below in detail while referring to the accompanying drawings.

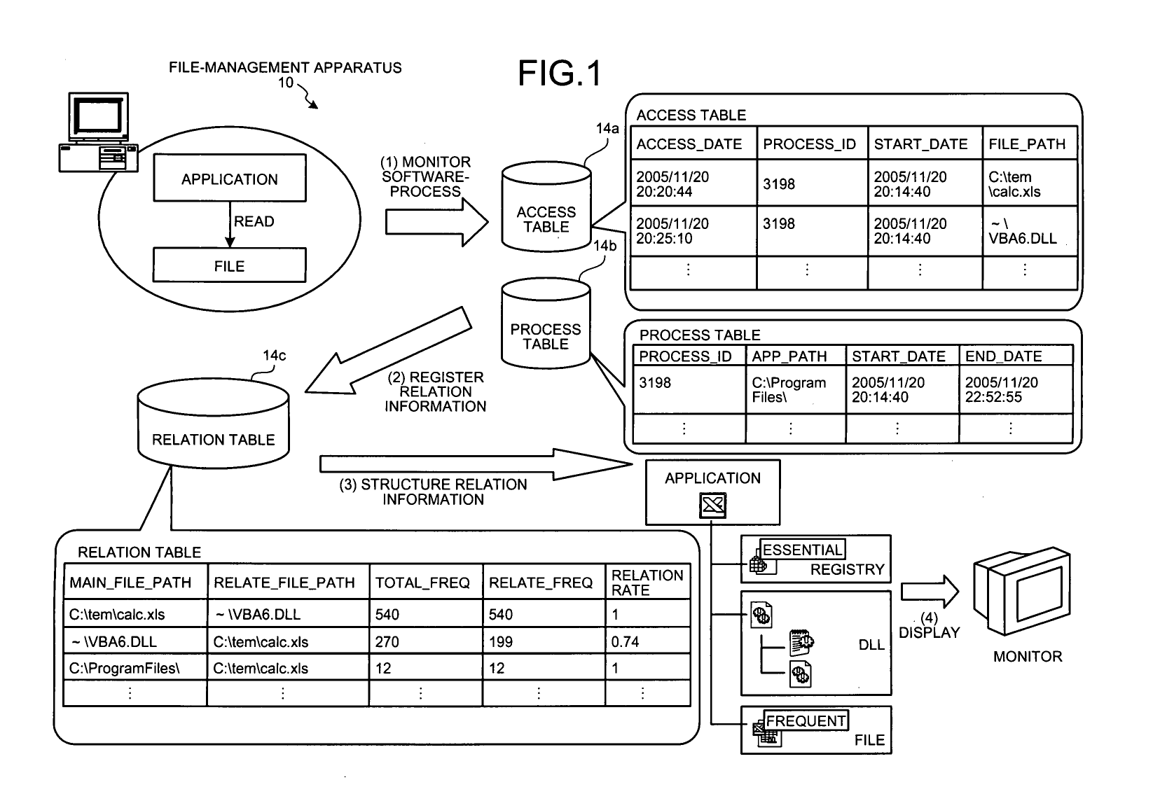

FIG. 1 is a schematic for explaining an outline and features of a file-management apparatus 10 according to a first embodiment of the present invention. The file-management apparatus 10 manages files read by software. The file-management apparatus 10 provides dynamic relations among the files correctly to a user.

More specifically, the file-management apparatus 10 includes an access table 14a, a process table 14b, and a relation table 14c. The access table 14a stores therein a process ID (PROCESS_ID) that distinguishes a unique boot process (hereinafter, “process”) from other processes in association with a file path (FILE_PATH) that identifies a file read in the process. The process table 14b stores therein the process ID in association with an application path (APP_PATH) that is booted with each process. The relation table 14c determines a certain file as a main file and stores its file path (MAIN_FILE_PATH), and determines files that are read in the process which read main file as relate files and stores those file path (RELATE_FILE_PATH) The file-management apparatus 10 monitors the process of the software (for example, application), and stores information on the process and an access thereto in the access table 14a or the process table 14b (see (1) in FIG. 1). More specifically, the file-management apparatus 10 acquires the process ID, the file path, and the application path; registers the process ID to the-access table 14a in association with the file path; and registers the process ID to the process table 14b in association with the application path.

The file-management apparatus 10 registers the name of the related file with respect to each main file in the relation table 14c (see (2) in FIG. 1). More specifically, the file-management apparatus 10 associates paths of the files (for example, C:\tem\calc.xls and ˜\VBA6.DLL) having an identical process ID (for example, 3198) and store them in the relation table 14c as the main file and the related file respectively.

The file-management apparatus 10 creates a tree that indicates the logical relational structure among the files based on the relations in the relation table 14c (see (3) in FIG. 1), and displays the tree on an output unit such as a monitor (see (4) in FIG. 1). More specifically, the file-management apparatus 10 retrieves an application path (for example, C:\ProgramFiles\) as a main file from the process table 14b, retrieves paths of the files related to the application (for example, C:\tem\calc.xls) from the relation table 14c, creates the tree according to the relation between the main file and each of the related files, and displays the tree on the output unit.

As described above, the file-management apparatus 10 can register the logical relation among the files based on dynamic information, and provide dynamic relation among the files correctly to a user.

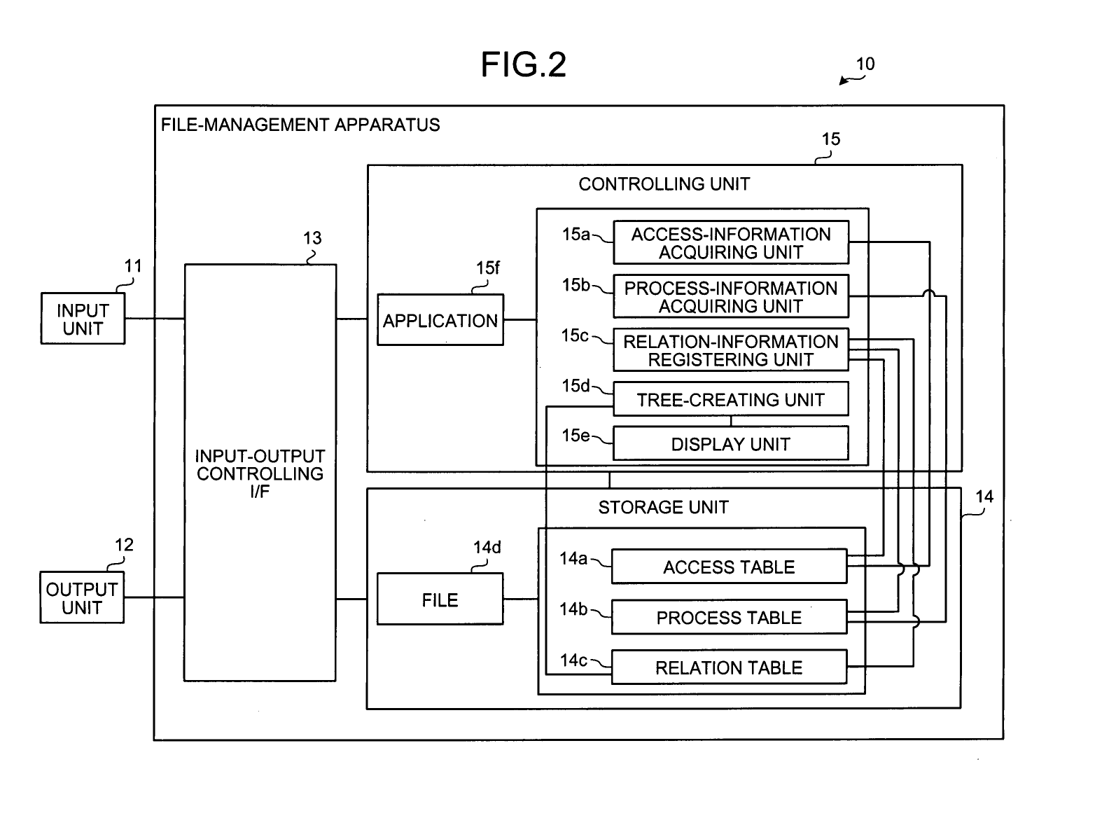

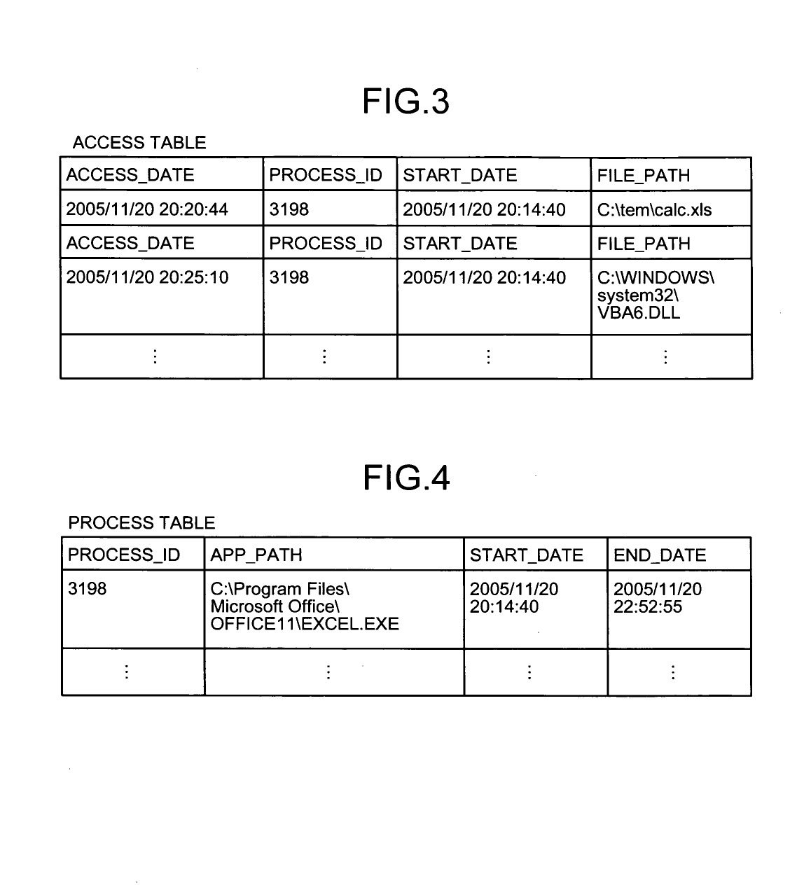

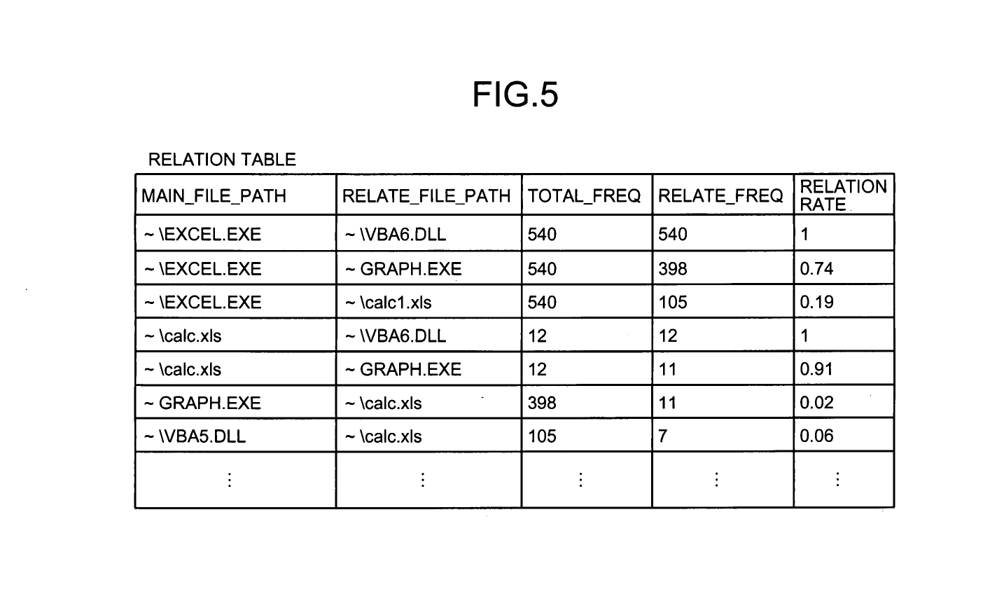

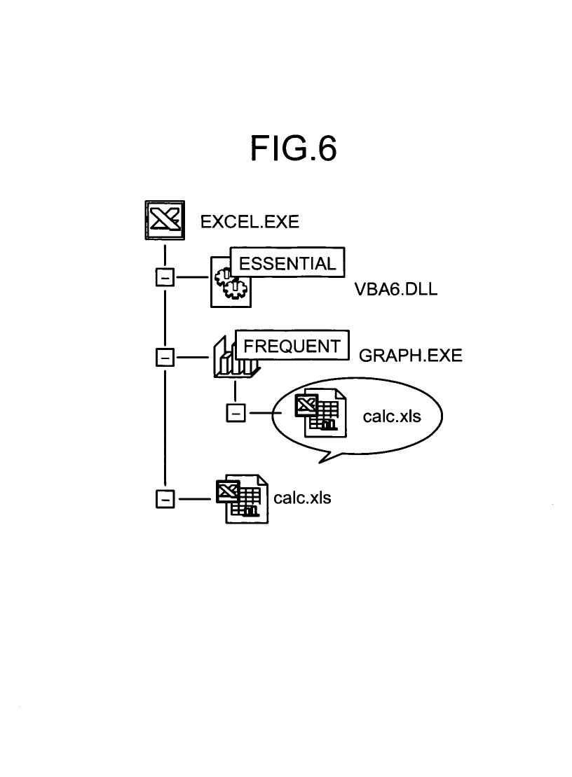

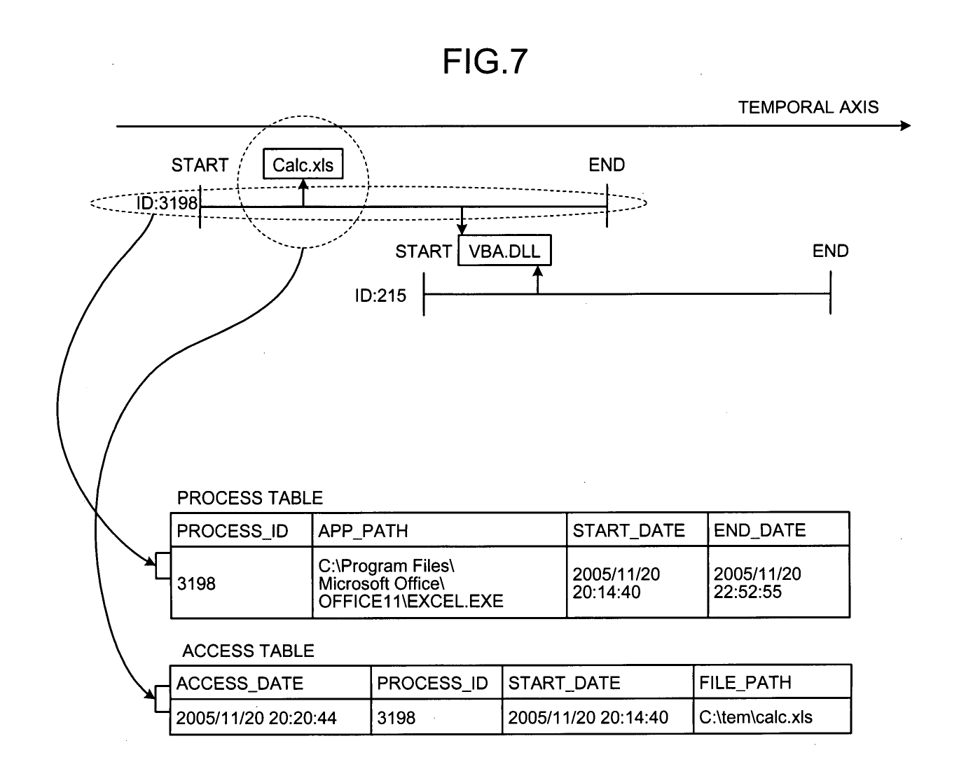

FIG. 2 is a block diagram of the file-management apparatus 10; FIG. 3 is an example of the contents of the access table; FIG. 4 is an example of the contents of the process table; FIG. 5 is an example of the contents of the relation table; FIG. 6 is an example of the tree to be displayed; and FIG. 7 is a schematic for explaining how the boot process is monitored. As shown in FIG. 2, the file-management apparatus 10 includes an input unit 11, an output unit 12, an input-output controlling interface (IF) unit 13, a storage unit 14, and a controlling unit 15.

The input unit 11 inputs information, and is operated through an operation panel, a switch, a button, or the like. More specifically, the input unit 11 accepts and inputs threshold values of essential, frequent and the like to be explained later.

The output unit 12 outputs the information. More specifically, the output unit 12 includes a monitor, a speaker, a lamp, and the like, and displays the tree thereon.

The input-output controlling IF unit 13 controls data transfer between the input unit 11 or the output unit 12 and the storage unit 14 or the controlling unit 15.

The storage unit 14 stores therein data and program required for procedures performed by the controlling unit 15, and includes the access table 14a, the process table 14b, the relation table 14c, and a file 14d.

As shown in FIG. 3, the access table 14a stores therein an ACCESS_DATE, meaning the date and the time when the access to the file starts, the PROCESS_ID, a START_DATE, meaning the date and the time when the process starts, and the FILE_PATH in association with one another.

As shown in FIG. 4, the process table 14b stores therein the PROCESS_ID, the APP_PATH, the START_DATE, and an END_DATE, meaning the date and the time when the process terminates, in association with one another.

As shown in FIG. 5, the relation table 14c stores therein the MAIN_FILE_PATH, the RELATE_FILE_PATH, a TOTAL_FREQ, meaning the number of processes in which the main file is read, and a RELATE_FREQ, meaning the count of reading the related file in the same process as the main file, in association with one another.

The file 14d stores therein a group of commands read by an application 15f to be explained later.

The controlling unit 15 includes programs that define various procedures and internal memories that store therein required data, and performs the procedures using the programs and the internal memories. More specifically, the controlling unit includes an access-information acquiring unit 15a, a process-information acquiring unit 15b, a relation-information registering unit 15c, a tree-creating unit 15d, a display unit 15e, and the application 15f.

The access-information acquiring unit 15a monitors the process of the application and acquires information related to the access. As shown in FIG. 7, when the file starts to be accessed, the access-information acquiring unit 15a acquires and stores in the access table 14a the ACCESS_DATE (for example, Nov. 20, 2005:20:44), the PROCESS_ID (for example, 3198), the START_DATE (for example, Nov. 20, 2005-20:14:40), and the FILE_PATH (for example, C:\tem\calc.xls).

The process-information acquiring unit 15b monitors the process of the application and acquires information related to the process. As shown in FIG. 7, when the process starts, in other words, when application file starts to be read and run, the process-information acquiring unit 15b acquires and stores in the process table 14b the PROCESS_ID, the APP_PATH (for example, C:\Program-Files\) and the START_DATE, and stores the END_DATE (for example, Nov. 20, 2005:52:55) when process will stop.

The relation-information registering unit 15c registers the path of the file read in the process that read the main file as related file with respect to each main file based on the access table 14a, computes a relation rate that indicates the proportion of processes in which both of the file and the related file are read to the processes in which the file is read, and registers the relation rate in the relation table 14c. More specifically, the relation-information registering unit 15c registers the path of the main file, the path of the related file, the total read count that indicates the number of the processes in which the main file path is read, and the count of the related file called in the same process as the main file, to the relation table 14c. The procedure is to be detailed later.

The tree-creating unit 15d creates the tree indicating the logical relational structure among the files. More specifically, the tree-creating unit 15d creates the tree based on the process table 14b and the relation table 14c. To display a file that is already included in the tree, the tree-creating unit 15d indicates a virtual link of the file. For a file with the relation rate higher than a predetermined first threshold, the file is indicated as an essential file, and for a file with the relation rate lower than the first threshold and higher than a predetermined second threshold, the file is displayed as a frequently-used file. The procedure is to be detailed later.

The display unit 15e displays the tree on the output unit 12 as shown in FIG. 6.

The application 15f reads the group of commands from the file 14d, and achieves a specific operation such as a numeric computation.

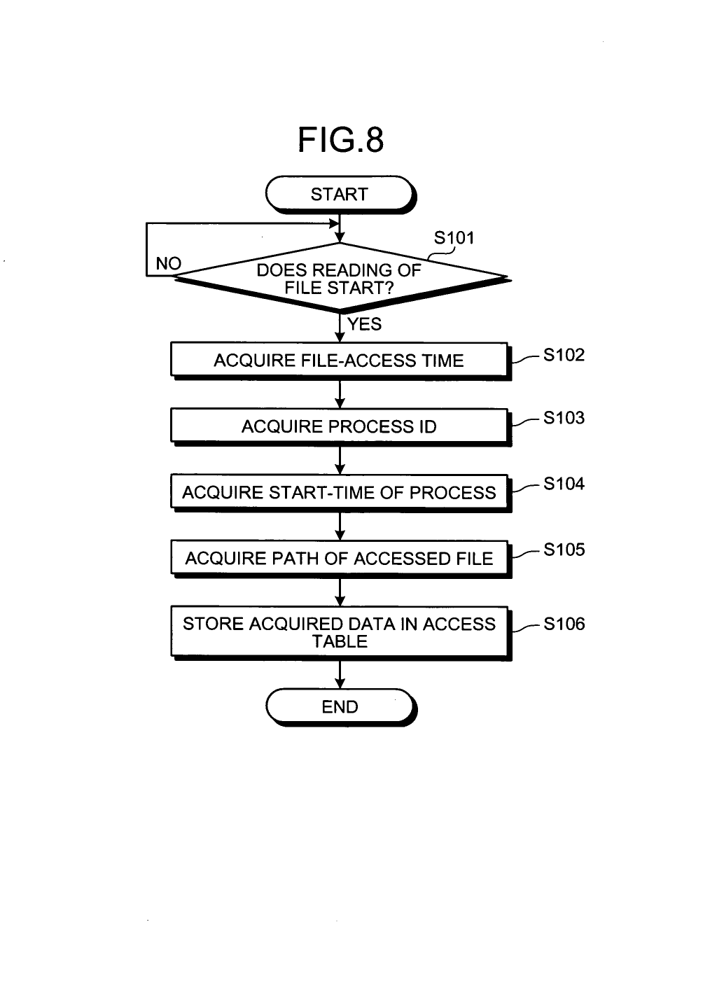

FIG. 8 is a flowchart for explaining a process of acquiring access information in the file-management apparatus 10. When the file starts to be read (YES at step S101), the access-information acquiring unit 15a acquires the ACCESS_DATE (step S102), acquires the PROCESS_ID (step S103), acquires the. START_DATE (step S104), acquires the FILE_PATH (step S105), and stores the information acquired in steps S102 to S105 in the access table 14a (step S106).

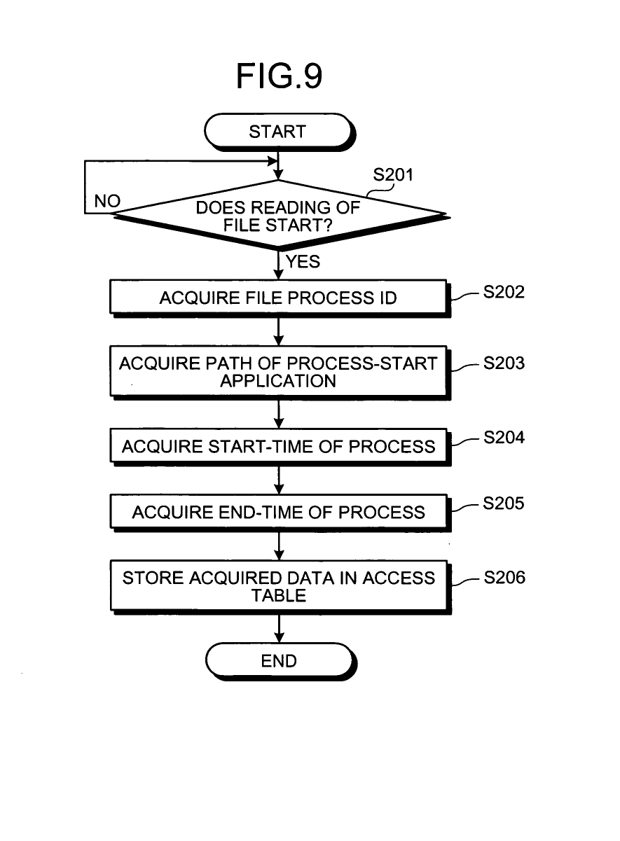

FIG. 9 is a flowchart for explaining a process of acquiring process information. When application file starts to be read (YES at step S201), in other words, when process starts, the process-information acquiring unit 15b acquires the PROCESS_ID (step S202), acquires the APP_PATH (step S203), acquires the START_DATE (step S204), acquires the END_DATE (step S205), and stores the information acquired in steps S202 to S205 in the process table 14b (step S206).

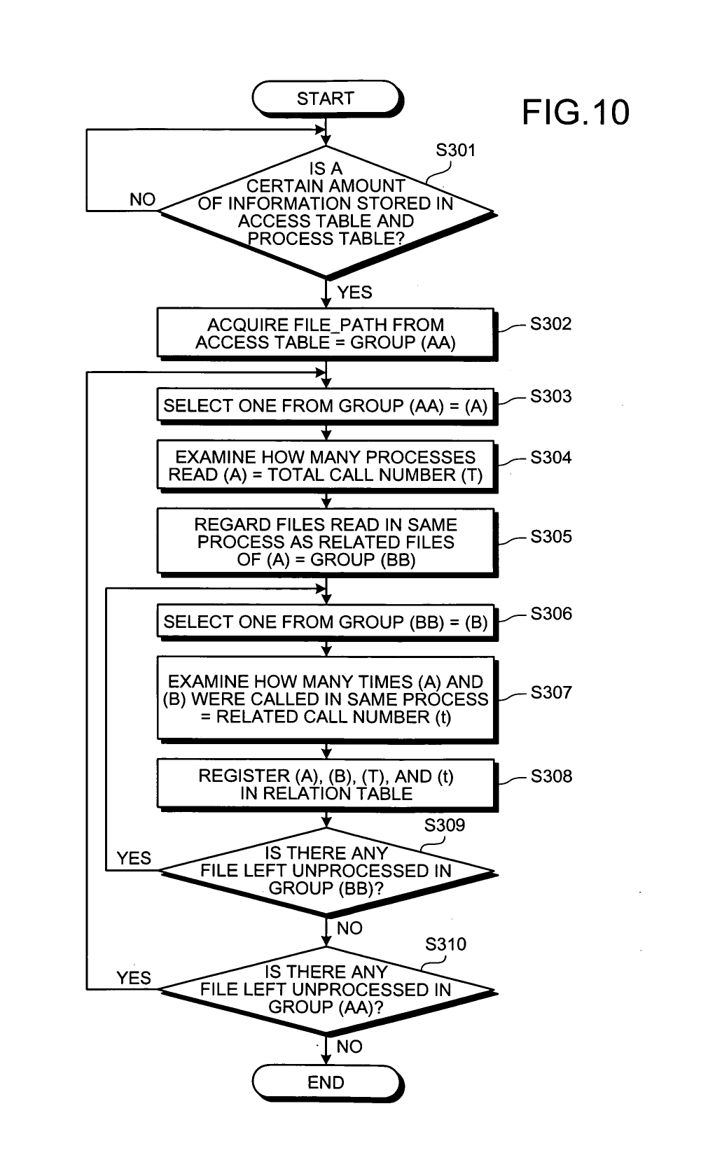

FIG. 10 is a flowchart for explaining a process of registering relation information. When a certain amount of information is stored in the access table 14a and the process table 14b (YES at step S301), the relation-information registering unit 15c acquires a plurality of file paths (group AA) from the access table 14a (step S302), selects one file path from the group AA (step S303), and examines the total read number T that indicates the number of processes in which the selected file path A is read (step S304).

Assuming that a plurality,of files read in the same process as A is group BB (step S305), the relation-information registering unit 15c selects one of the related-file paths from the group BB (step S306), assuming that the path of the selected related file is B, examines t that indicates how many times A and B are called in the same process (step S307), and registers A, B, T, and t in the relation table 14c (step S308).

The relation-information registering unit 15c then searches for any files left unprocessed in the group BB (step S309). When there is any file left (YES at step S309), the relation-information registering unit 15c selects a related-file path and perform the procedure until there is no file left in the group BB. When there is no file left in the group BB (NO at step S309), the relation-information registering unit 15c searches for a file left unprocessed in the group AA (step S310). When there is any file left in the group AA (YES at step S310), the relation-information registering unit 15c selects a related-file path and repeat the procedure. When there is no file left in the group BB (NO at step S310), the relation-information registering unit 15c terminates the procedure.

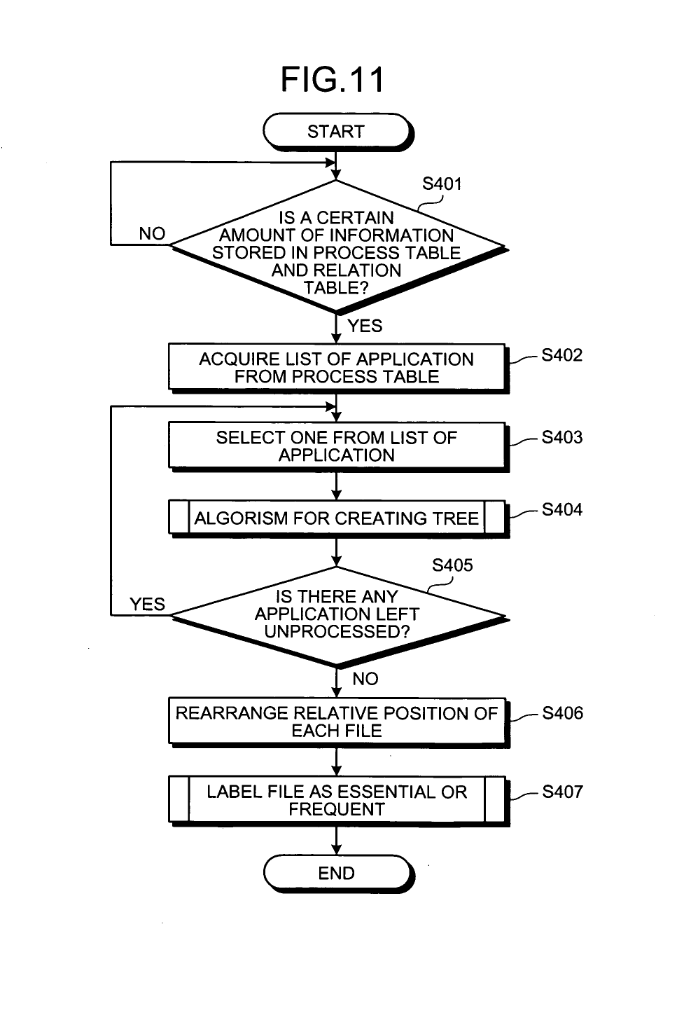

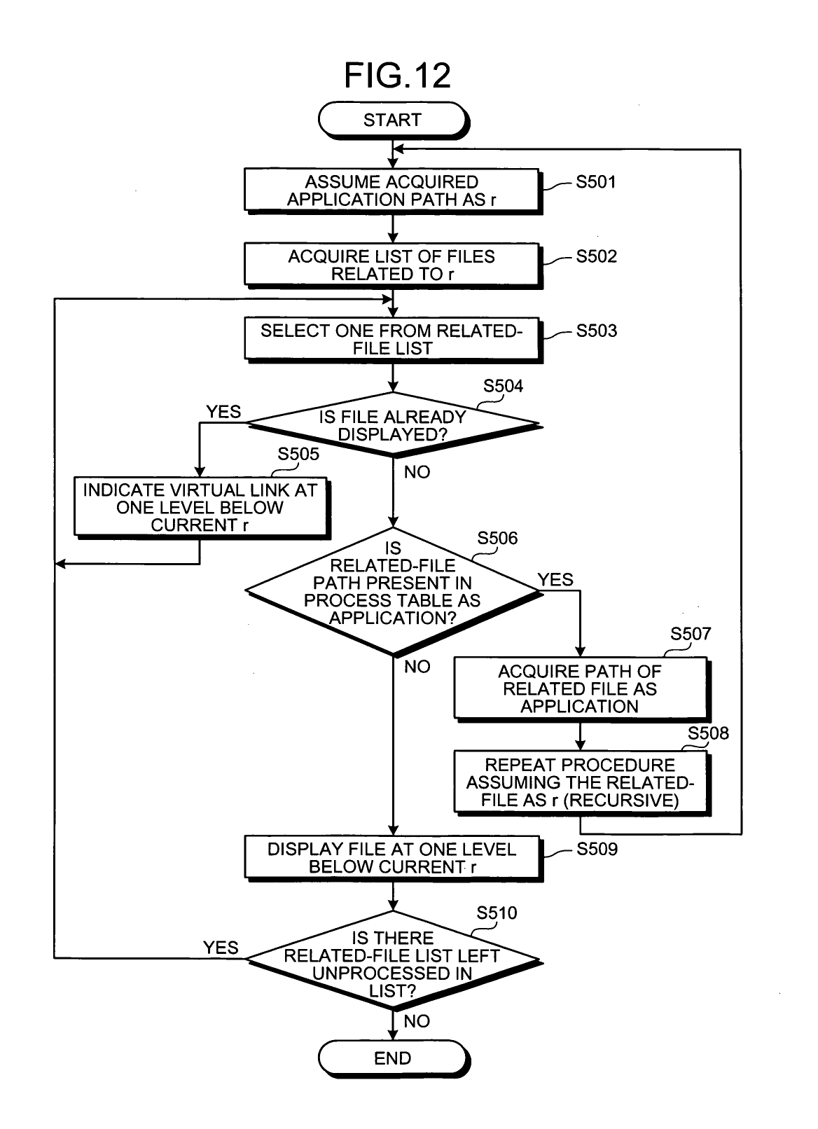

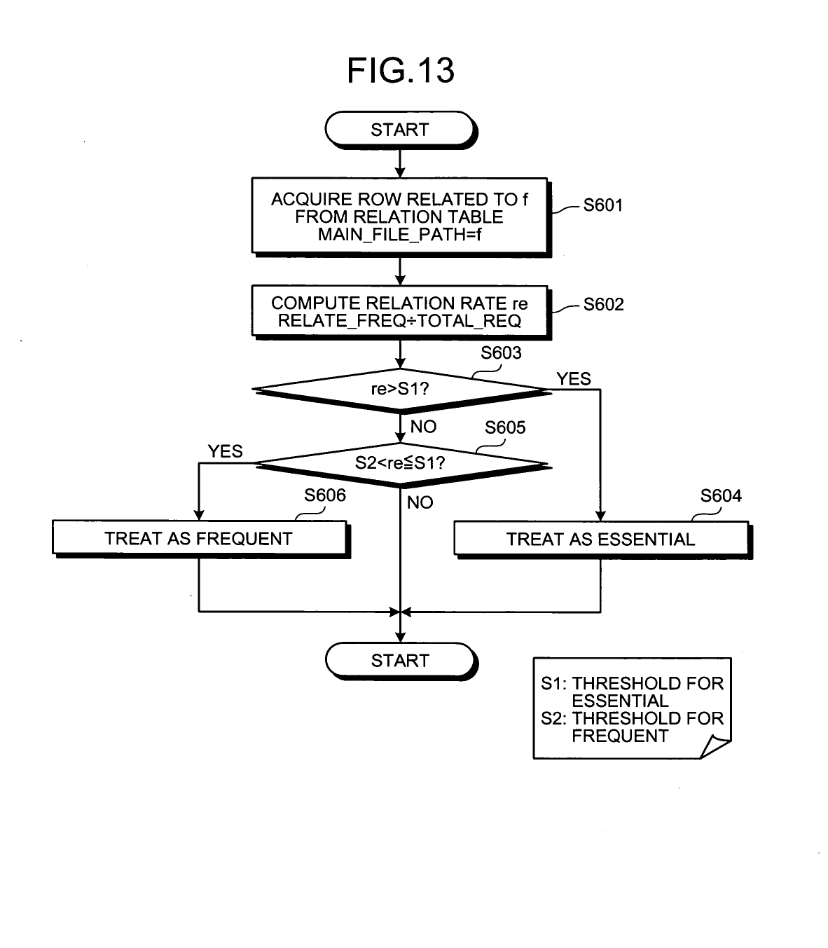

FIG. 11 is a flowchart for explaining how to create the tree; FIG. 12 is a flowchart for explaining algorism for creating the tree; and FIG. 13 is a flowchart for explaining a process of labeling each file as essential or frequent.

As shown in FIG. 11, when a certain amount of information is stored in the process table 14b and the relation table 14c (YES at step S401), the relation-information registering unit 15c acquires a list of application paths from the process table 14b (step S402). The tree-creating unit 15d then selects an application path from the list (step S402), and creates the tree (step S404).

To explain the algorism for creating the tree in detail with reference to FIG. 12, the tree-creating unit 15d assumes that the path of the acquired application is r (step S501), and acquires a list of files related to r from the relation table 14c (step S502).

The tree-creating unit 15d selects a path from the list of the related files (step S503), and examines whether the related file is already indicated on the tree (step S504). When the related file is indicated on the tree (YES at step S504), the tree-creating unit 15d indicates a virtual link to the related file at a hierarchical level just below the current level of r (step S505), and returns to the procedure for selecting another path from the list of the related files. When the related file is not indicated on the tree (NO at step S504), the tree-creating unit 15d searches the process table 14b for the path of the selected related file as the application (step S506). When the related-file path is present as the application (YES at step S506), the tree-creating unit 15d acquires the path of the file related to the application (step S507), and repeat the procedure assuming that the related-file path is r (step S508).

When the path of the related file is not present as an application in the process table 14b (NO at step S506), the tree-creating unit 15d indicates the virtual link to the related file at the hierarchical level just below the current level of r (step S509), and searches the list of the related files for any related file left unprocessed (step S510). When there is any related file left in the list (YES at step S510), the tree-creating unit 15d acquires one of the unprocessed related files from the list to repeat the procedure. When there is not any related file left in the list (NO at step S510), the tree-creating unit 15d terminates creating the tree.

Returning to the explanation of FIG. 11, the tree-creating unit 15d searches for any application path left unprocessed in the list of application (step S405), and when there is any application path left in the list (YES at step S405), the tree-creating unit 15d selects one of the unprocessed application path from the list to repeat the procedure. When there is not any application path left in the list (NO at step S405), the tree-creating unit 15d rearranges the relative position of each file on the tree (step S406), and labels the file as essential or frequent (step S407).

As shown in FIG. 13, the tree-creating unit 15d acquires a row related to the selected MAIN_FILE_PATH (including the data of RELATE_FILE_PATH, TOTAL_FREQ, and RELATE_FREQ) (step S601), and computes the relation rate re by dividing the numeral value of the RELATE_FREQ by the numeral value of TOTAL_FREQ (step S602).

The tree-creating unit 15d then compares the re with an essential threshold S1 input from the input unit 11 (step S603). When the re is larger than S1 (YES at step S603), the tree-creating unit 15d regards the file as essential and indicates the sign “essential” on the file in the tree (step S604). When the re is equal to or smaller than S1 (NO at step S603) and larger than a frequent threshold S2 (YES at step S605), the tree-creating unit 15d regards the file as frequent and indicates the sign “frequent” on the file (step S606). When the re is equal to or smaller than S2. (NO at step S605), the tree-creating unit 15d terminates the process without labeling the file essential or frequent.

As described above, the file-management apparatus 10 monitors the process of the software; registers the process ID to the access table 14a in association with the name of the file read in the process; and registers the file name to the process table 14b in association with other files read in the same process as the related file, with reference to the access table 14a. As a result of registering logical relations among the files based on the dynamic information, the file-management apparatus 10 can provide the dynamic relation among the files correctly to the user.

According to an aspect of the first embodiment, the file-management apparatus 10 creates the logical relation structure that indicates the logical relation among the files registered in the relation table 14c and displays the logical relation structure on a predetermined display unit. This enables the user to visually understand the relation among the files.

According to another aspect of the first embodiment, the file-management apparatus 10 computes the relation rate that shows the proportion of processes in which both of the main file and the related file are read to the processes in which the main file is read, and registers the relation rate in the relation table 14c. Because of this, the user can be provided with the proportion at which the files are related to each other.

According to still another aspect of the first embodiment, the file-management apparatus 10 indicates that the file with the relation rate higher than the first threshold is essential, and that the file with the relation rate lower than the first threshold but larger than the second threshold is frequent. This enables the user to visually understand the degree of relations among the files.

According to still another aspect of the first embodiment, the file-management apparatus 10 indicates the virtual link to display a file that is already displayed in the tree. This can prevent the file from being displayed redundantly.

While the first embodiment was explained above, the present invention can be carried out in other forms as below:

### (1) To Copy File

Upon receiving a request to copy a predetermined file, the files related to the predetermined file can be copied at the same time.

More specifically, upon receiving the request to copy the main file, the file-management apparatus 10 acquires the related files related to the main file from the relation table 14c, and copies the related files along with the main file based on the relation among those (for example, the relation rate between the related file and the main file is higher than a predetermined threshold).

In this manner, upon receiving a command to output the file to an external terminal, the file-management apparatus 10 outputs the files related to the file, which can save the user's trouble to manually output each of the related files.

### (2) Timing of Processing

While the relation information is registered and the tree is created when a predetermined amount of information is stored in a predetermined table in the first embodiment, the present invention is not limited to the timing described above. The registration of the relation information and the creation of the tree can be performed upon receiving a command from the user.

### (3) System Configuration

The components of each unit shown in the drawings are functionally conceptual but not necessarily configured physically as shown. For example, the access-information acquiring unit 15a and the process-information acquiring unit 15b can be combined. Further, each processing function performed in each unit can be realized in the form of a CPU, a program executed by the CPU, or hardware based on the wired logic.

All or part of the procedures explained in the first embodiment to be performed automatically can be performed manually, and vice versa. The information including the procedures of processing and controlling, specific names, various data and parameter described above or shown in the drawings can be freely changed if not otherwise specified.

### (4) Computer Program

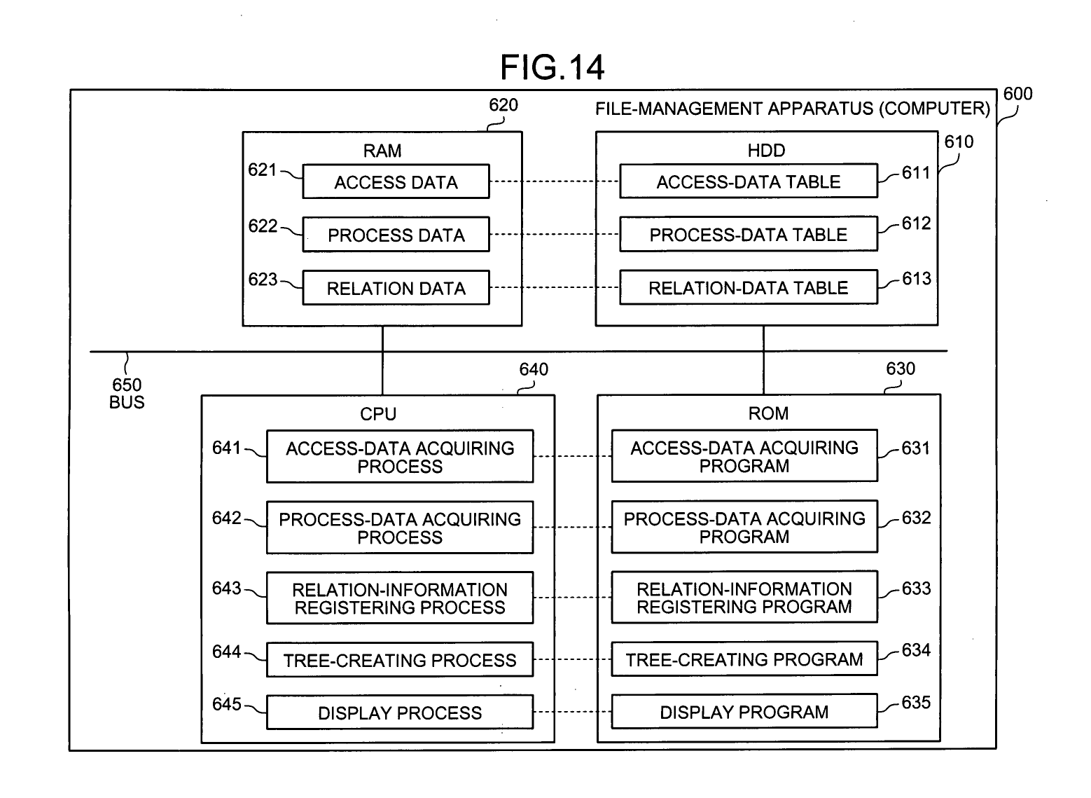

All or some of the procedures, methods, processes, or steps explained above can be performed by executing a computer program on a computer. FIG. 14 is a block diagram of a computer that executes a computer program (hereinafter, “file-management program”), thereby implementing the procedures, methods, processes, or steps.

A computer 600 that operates as a file management unit includes a hard disk drive (HDD) 610, a random access memory (RAM) 620, a read only memory (ROM) 630, and a central processing unit (CPU) 640, each connected through a bus 650.

The ROM 630 stores therein the contents of the file management unit that functions as the preceding embodiment, namely, an access-data acquiring program 631, a process-data acquiring program 632, a relation-information registering program 633, a tree-creating program 634, and a display program 635 in advance. Like each components of the file-management apparatus shown in FIG. 2, the programs 631 to 635 can be combined or separated accordingly.

By the CPU 640 executing the programs 631 to 635 as read from the ROM 630, the programs 631 to 635 start to function as an access-data acquiring process 641, a process-data acquiring process 642, a relation-information registering process 643, a tree-creating process 644, and a display process 645 respectively. The processes 641 to 645 correspond to the access-information acquiring unit 15a, the process-information acquiring unit 15b, the relation-information registering unit 15c, the tree-creating unit 15d, and the display unit 15e shown in FIG. 2 respectively.

The HDD 610 includes an access-data table 611, a process-data table 612, and a relation-data table 613. The access-data table 611, the process-data table 612, and the relation-data table 613 corresponds to the access table 14a, the process table 14b, and the relation table 14c respectively. The CPU 640 registers data to the access-data table 611, the process-data table 612, and the relation-data table 613; stores an access data 621, a process data 622, and a relation data 623 from each data table in the RAM 620; and manages position information based on the data stored in the RAM 620.

According to an aspect of the present invention, it is possible to correctly provide the dynamic relation among the files to the user.

According to another aspect, the user can visually understand the relation among the files.

According to still another aspect, the user can be provided with the proportion at which the files are related to each other.

According to still another aspect, the user can visually understand the degree of relation among the files.

According to still another aspect, it is possible to prevent the file from being displayed redundantly.

According to still another aspect, it is possible to save the user's trouble to manually output the related files.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to manage files read by software when the software is running, the software including a plurality of process, the computer program causing the computer to execute:
monitoring a process of the software to register file names of digital files read in the process in an access table in association with a process identification that uniquely identifies the process; and
registering a file name of a digital file read in the process as a related file in a relation table in association with each digital file in the access table.

2. The computer-readable recording medium according to claim 1, wherein the computer program further causing the computer to execute creating a logical relation structure that indicates a logical relation among the digital files registered in the relation table accordingly to display the logical relation structure on a display unit.

3. The computer-readable recording medium according to claim 1, wherein the registering includes computing a relation rate that indicates a proportion of processes in which both of the digital file and the related file-are read to the processes in which at least the digital file is read, and further registering the relation rate in the relation table.

4. The computer-readable recording medium according to claim 3, wherein the creating further includes indicating that a file having a relation rate higher than a predetermined first threshold is essential, and that a file having a relation rate lower than the first threshold and higher than a predetermined second threshold is frequently used.

5. The computer-readable recording medium according to claim 2, wherein the creating further includes indicating a virtual link to a digital file-that is already included in the logical relation structure.

6. The computer-readable recording medium according to claim 1, wherein the computer program further causing the computer to execute, when accepting a command to output a predetermined digital file to an external terminal, outputting another digital file related to the predetermined digital file to the external terminal along with the predetermined digital file based on the relation between the digital files in the relation table.

7. A file-management apparatus comprising:
a monitoring unit that monitors a process of software to register file names of digital files read in the process in an access table in association with a process identification that uniquely identifies the process; and
a relation-registering unit that registers a file name of a digital file read in the process as a related file in a relation table in association with each digital file in the access table.

8. A file-management method comprising:
monitoring a process of software to register file names of digital files read in the process in an access table in association with a process identification that uniquely identifies the process; and
registering a file name of a digital file read in the process as a related file in a relation table in association with each digital file in the access table.
